(19) United States
(12) Patent Application Publication
(10) Pub. No.: US 2015/0007092 A1
(43) Pub. Date: Jan. 1, 2015

(54) METHOD AND ELECTRONIC DEVICE FOR DISPLAYING E-BOOK

(71) Applicant: Samsung Electronics Co., Ltd., Gyeonggi-do (KR)

(72) Inventor: Jongyong Park, Seoul (KR)

(21) Appl. No.: 14/318,398

(22) Filed: Jun. 27, 2014

(30) Foreign Application Priority Data
Jun. 28, 2013 (KR) 10-2013-0076088

(51) Int. Cl. G06F 3/0483; G06F 3/0486; G06F 3/0484

(52) U.S. Cl. CPC G06F 3/0483; G06F 3/0484; G06F 3/0486
USPC 715/776

(57) ABSTRACT

A method for displaying an e-book in an electronic device includes displaying the e-book on a screen, and when a page flipping event is detected on a page of the e-book, flipping the page with additional information displayed on a lateral side of the flipping page. An electronic device for displaying an e-book includes a screen configured to display the e-book, and a controller configured to detect a page flipping event on a page of the e-book, and control the screen to display the page being flipped, wherein additional information is displayed on a lateral side of the page while being flipped. Other embodiments are also disclosed.

### CROSS-REFERENCE TO RELATED APPLICATION AND CLAIM OF PRIORITY

The present application is related to and claims the benefit under 35 U.S.C. §119(a) of a Korean patent application No. 10-2013-0076088 filed on Jun. 28, 2013 in the Korean intellectual property office, the entire disclosure of which is hereby incorporated by reference.

### TECHNICAL FIELD

The present disclosure relates to a method and electronic device for displaying an e-book. More particularly, the present disclosure relates to a method and electronic device for displaying at least one page, being flipped, of an e-book in a three-dimensional form and further displaying additional information on one side of the three-dimensional form.

### BACKGROUND

Nowadays an electronic book (hereinafter, abbreviated to an e-book) based on text-to-speech (TTS) technology involves in general various animation effects. Such an animation effect promotes an interaction between a user and an e-book, thus stimulating a user's interest in comparison with case of reading a traditional book.

As one of such animation effects, a page flipping or rolling effect has been used. However, this animation effect gives a simple effect in expressions to turn the pages of an e-book.

With the use of e-book contents popularized recently, providers and consumers of e-book contents have an increasing desire for more various interactive effects.

### SUMMARY

A method for displaying an e-book in an electronic device is provided. The method includes displaying the e-book on a screen, and when a page flipping event is detected on a page of the e-book, flipping the page with additional information displayed on a lateral side of the flipping page.

In some embodiments, the page flipping event happens by at least one of user's inputs including a touch-and-drag, a blow on the electronic device, and a tilting of the electronic device.

In some embodiments, the page includes front and back sides, top and bottom sides, and a lateral side in a three-dimensional form.

In some embodiments, the displaying the selected page includes determining a thickness of the page, the thickness being adequate to display the additional information, and displaying the page with the determined thickness while being flipped.

In some embodiments, wherein the thickness of the page is determined based on a font size of letters to be displayed.

In some embodiments, the additional information comprises at least one of an advertisement, a summary on the page, information on the e-book, and index information.

In some embodiments, the additional information comprises a title of the e-book.

In some embodiments, the additional information comprises a title of a chapter that the page belongs to.

In some embodiments, the additional information comprises a number of the page being flipped.

In some embodiments, the displaying the page includes selecting a texture of the page in the three-dimensional form, and displaying the page having the selected texture.

An electronic device for displaying an e-book is provided. The electronic device includes a screen configured to display the e-book, and a controller configured to detect a page flipping event on a page of the e-book, and control the screen to display the page being flipped, wherein additional information is displayed on a lateral side of the page while being flipped.

In some embodiments, the page flipping event happens by at least one of a user's inputs including a touch-and-drag, a blow on the electronic device, and a tilting of the electronic device.

In some embodiments, the page includes at least one of a top side, a bottom side and a lateral side in a three-dimensional form.

In some embodiments the controller is further configured to determine a thickness of the flipping page, the thickness being adequate to display the additional information, and display the page with the determined thickness while being flipped.

In some embodiments, the thickness of the page is determined based on a font size of letters to be displayed.

In some embodiments, the additional information comprises at least one of an advertisement, summary on the page, information on the e-book, and index information.

In some embodiments, the additional information comprises a title of the e-book.

In some embodiments, the additional information comprises a title of a chapter that the page belongs to.

In some embodiments, the additional information comprises a number of the page being flipped.

In some embodiments, the controller is further configured to select a texture of the page the three-dimensional form, and control the display unit to display the page having the selected texture.

To address the above-discussed deficiencies, it is a primary object to provide a method and electronic device for displaying an e-book by representing a page or pages, being currently flipped, of the e-book in a three-dimensional form in response to a page flipping event and further by displaying additional information on at least one side of the three-dimensional form.

An embodiment in this disclosure may provide a method for displaying an e-book in an electronic device. This method comprises displaying the e-book; if a page flipping event is detected, displaying at least one page selected corresponding to the page flipping event, wherein the selected page is displayed in a three-dimensional form as if being flipped, and wherein additional information is displayed on at least one side of the three-dimensional form.

Another embodiment in this disclosure may provide an electronic device for displaying an e-book. This device comprises a display unit configured to display the e-book; and a control unit configured to control the display unit to display at least one page selected corresponding to the page flipping event if a page flipping event is detected, wherein under the control of the control unit, the display unit is further configured to display the selected page in a three-dimensional form as if being flipped, and to display additional information on at least one side of the three-dimensional form.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device in accordance with an embodiment of the present disclosure.

FIG. 2 is a flow diagram illustrating a method for displaying an e-book in accordance with an embodiment of the present disclosure.

FIG. 3 is a schematic diagram illustrating an example of a page flipping event in accordance with an embodiment of the present disclosure.

FIG. 4 is a schematic diagram illustrating an example of displaying a flipped page in a three-dimensional form in accordance with an embodiment of the present disclosure.

FIG. 5 is a schematic diagram illustrating an example of an advertisement displayed as additional information on one side of a three-dimensional form in accordance with an embodiment of the present disclosure.

FIG. 6 is a schematic diagram illustrating an example of e-book summary information displayed as additional information on one side of a three-dimensional form in accordance with another embodiment of the present disclosure.

### DETAILED DESCRIPTION

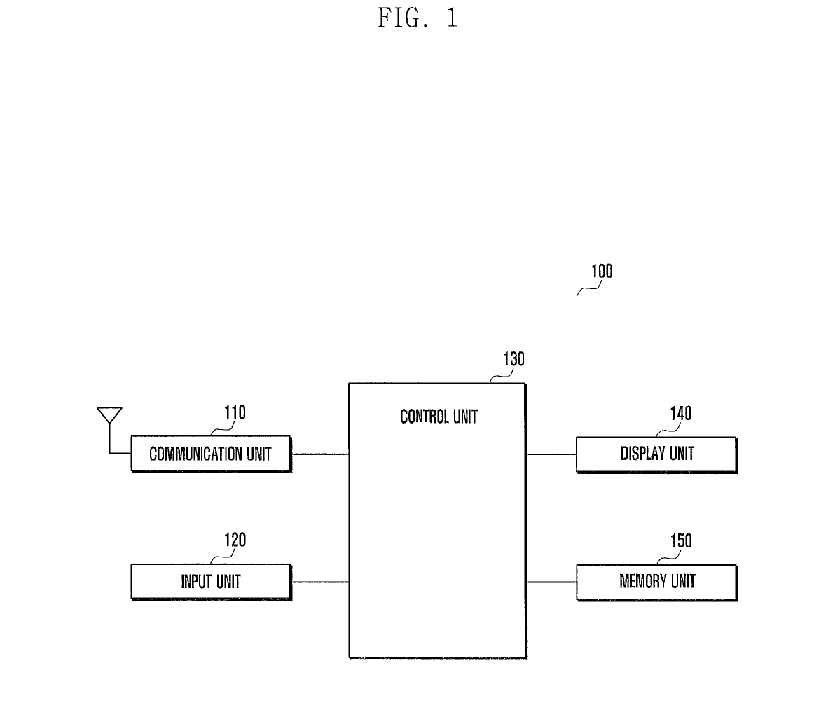

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a page” includes reference to one or more of such pages.

The present disclosure may be applied to any type of electronic devices that offer an e-book.

Such electronic devices that offer an e-book function can include a smart phone, a portable terminal, a mobile terminal, a personal digital assistant (PDA), a portable multimedia player (PMP), a notebook, a note pad, a tablet PC, a smart TV, a smart refrigerator, or any other apparatus capable of providing an e-book function.

FIG. 1 is a block diagram illustrating an electronic device in accordance with an embodiment of the present disclosure.

Referring to FIG. 1, the electronic device 100 can include a communication unit 110, an input unit 120, a control unit 130, a display unit 140, and a memory unit 150.

The communication unit 110 can perform a data communication with any external entity. Especially, the communication unit 110 can include any kind of wired/wireless communication module based on wired or wireless communication technology and perform a data communication with an external entity through such a communication module. Wireless communication technology can include, but not limited to, Wireless LAN™ (WLAN™), Wi-Fi™, Wireless broadband™ (Wibro™), World interoperability for microwave access™ (Wimax™), High Speed Downlink Packet Access™ (HSDPA™), or the like. Meanwhile, wireless short-range communication technology can include, but not limited to, Bluetooth, RFID (Radio Frequency Identification), IrDA (Infrared Data Association), UWB (Ultra Wideband), ZigBee™, NFC (Near Field Communication), or the like. Additionally, wired short-range communication technology can include, but not limited to, USB (Universal Serial Bus), IEEE 1394, Thunderbolt of Intel, or the like. The communication unit 110 can include one or more communication modules designed for a data communication based on Bluetooth™, ZigBee™, UWB, NFC, wireless USB, WLAN™, or the like.

In various embodiments of this disclosure, the communication unit 110 can allow an e-book file to be downloaded from a web server under the control of the control unit 130. Further, the communication unit 110 can also allow additional information, such as an advertisement associated with an e-book file, to be downloaded.

The input unit 120 can create a manipulation signal in response to a user's input. The input unit 120 can be composed of a keypad, a dome switch, a jog wheel, a jog switch, or the like. Further, the input unit 120 can have a touch sensor, a pressure sensor, a proximity sensor, an electromagnetic sensor, etc., and can be designed in the form of a suitable pad such as a touch pad (a capacitive type, a resistive type, etc.), an Electro Magnetic Resonance (EMR) pad, an Electro Magnetic Interference (EMI) pad, or the like. Through such a sensor, the input unit 120 can detect a user's input produced by his or her body (e.g., a finger), a physical tool such as a stylus pen, or any other suitable input tool. The input unit 120 can be formed of two or more pads having a layer structure.

The input unit 120 can form a layer structure together with the display unit 140, thus acting as an input screen. For example, the input unit 120 can include an input pad having a touch sensor and be combined with the display unit 140 to form a TSP (Touch Screen Panel).

In various embodiments of this disclosure, the input unit 120 can detect a user's input that creates a page flipping event for an e-book. For example, a user's input can be a touch input, a touch-and-drag input, a hovering input, or the like.

The control unit 130 can control the whole operation of respective elements in the electronic device 100. Specifically, the control unit 130 can control the display unit 140 to display an e-book, and when a flipping event for any page of an e-book is detected through the input unit 120, can control the display unit 140 to display at least one page being flipped in response to the flipping event.

Additionally, while at least one page is being flipped, the control unit 130 can control the display unit 140 to display the page in a three-dimensional form and also display additional information on at least one side of the three-dimensional form.

The control unit 130 will be more fully described below with reference to drawings.

The display unit 140 displays any kind of information processed in the electronic device 100. For example, the display unit 140 can display a User Interface (UI) or Graphic UI (GUI) in connection with an e-book.

The display unit 140 can be formed of Liquid Crystal Display (LCD), Thin Film Transistor LCD (TFT-LCD), Organic Light Emitted Diode (OLED), Active Matrix OLED (AMOLED), a flexible display, a three-dimensional display, or the like.

The display unit 140 can form a layer structure together with a touch sensor and/or an electromagnetic sensor contained in the input unit 120, thus acting as a touch screen. In this case, the display unit 140 acting as a part of a touch screen can perform the function of input mechanism.

In embodiments of this disclosure, the display unit 140 can display an e-book under the control of the control unit 130 and also display user effects reproduced in response to a user's request.

The memory unit 150 can store programs or commands for the electronic device 100. The control unit 130 can selectively perform such programs or commands stored in the memory unit 150.

The memory unit 150 can include a storage unit of at least one of a flash memory type, a hard disk type, a multimedia card micro type, a card type memory (e.g., SD or XD memory, etc.), a Random Access Memory (RAM), a Static RAM (SRAM), a Read Only Memory (ROM), a Programmable ROM (PROM), an Electrically Erasable PROM (EEPROM), a magnetic memory, a magnetic disk, an optical disk, and the like.

In embodiments of this disclosure, the memory unit 150 can store at least one e-book. Specifically, the memory unit 150 can store an e-book file that has metadata on at least one e-book.

Elements shown in FIG. 1 are for example only, and the electronic device 100 can have more or less elements if necessary.

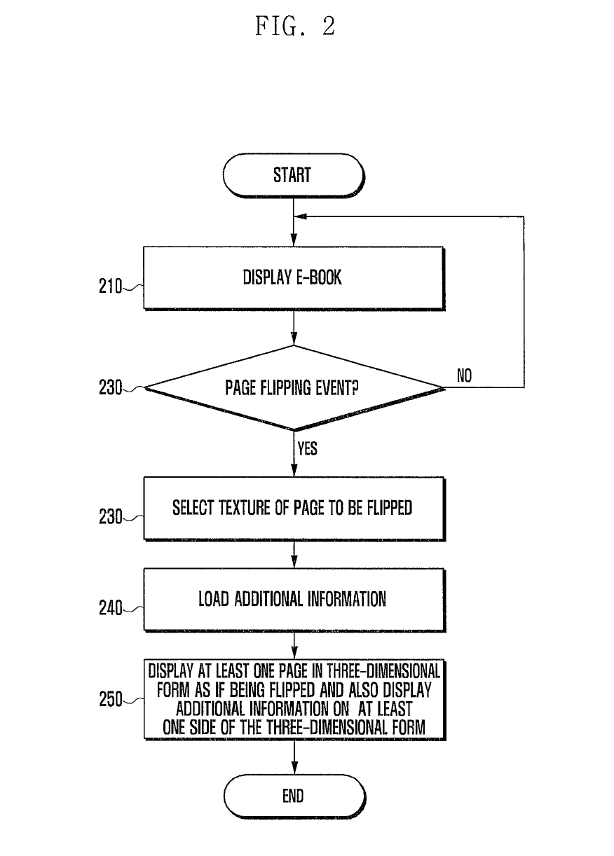

FIG. 2 is a flow diagram illustrating a method for displaying an e-book in accordance with an embodiment of the present disclosure.

Referring to FIG. 2, the control unit 130 controls the display unit 140 to display an e-book at operation 210. Specifically, the control unit 130 determines whether an input signal for requesting an e-book display is received through the input unit 120. This request for an e-book display can happen by mean of a user's input or a trigger of a selected application, program or service that requires the display of an e-book. When such a request for an e-book display happens, the control unit 130 controls the display unit 140 to display an e-book.

An e-book can be composed of at least one piece of content that can contain, for example, text, images, videos, flash images, sounds, and the like. An e-book is stored in the memory unit 150 and, in response to a user's request or if necessary, can be downloaded through the communication unit 110 under the control of the control unit 130. An e-book can have a suitable format such as PDF or ePub depending on a distribution form.

The control unit 130 acquires an e-book file to be displayed from the memory unit 150. Then the control unit 130 performs a parsing for the content of an e-book contained in an e-book file. Further, the control unit 130 creates a layout tree of the parsed content and also creates page separation information about the layout tree on the basis of the size of the display unit 140 and font information. Then, based on the created layout tree and the page separation information, the control unit 130 creates layout information about content to be displayed at a current page and, based on this, controls the display unit 140 to display the content of an e-book.

Under the control of the control unit 130, the display unit 140 can display at least one piece of content constituting an e-book with a selected layout in a readable form.

Referring to FIG. 3, the display unit 140 can display selected left and right pages of an e-book. Also, as shown in FIG. 3, the display unit 140 can represent such left and right pages of an e-book in a three-dimensional form from an arbitrary viewpoint. FIG. 3 shows an example of a lower viewpoint. Such a display form of an e-book is not limited specially, and an e-book can be displayed according to a variety of well-known techniques.

Next, at operation 220, the control unit 130 determines whether a page flipping event for an e-book is detected.

A page flipping event, also referred to as a page turn-over event, means an event for turning over at least one page in a state of displaying an e-book.

In one embodiment, a page flipping event can happen by a user's input such as a touch input, a touch-and-drag input, a hovering input, or the like. Such a user's input can be an input for selecting a page turn-over menu or an input occurring on a displayed page. When any input signal is received from the input unit 120, the control unit 130 can analyze the received input signal to determine whether the received input signal indicates a user's input corresponding to a page flipping event.

In another embodiment, a page flipping event can happen depending on a status change of the electronic device 100. For example, a status change of the electronic device 100 can include a detection of a blow around or on the electronic device 100, a variation in a tilt of the electronic device 100, or the like. In this case, the electronic device 100 can include a blow detecting sensor which is for detecting a blow, and/or at least one of a gravity sensor, a gyro sensor, or a magnetic sensor, which are for detecting a tilt of electronic device.

If the blow detecting sensor detects a blow around the electronic device 100, the control unit 130 can determine that a page flipping event happens. At this time, the control unit 130 can further determine the direction of a blow, the strength of a blow, or the like.

If the above-mentioned sensor detects a variation in a tile of the electronic device 100, the control unit 130 can determine that a page flipping event happens. At this time, the control unit 130 can further determine the direction of a tilt, the magnitude of a tilt, or the like. Only if the magnitude of a tilt is greater than a given threshold value, the control unit 130 can determine that an effective page flipping event happens.

Although some examples of a page flipping event are discussed above, these are exemplary only and not to be considered as a limitation of this disclosure. Alternatively, a page flipping event can happen based on any other technique.

FIG. 3 shows an example of a page flipping event that happens by a user's input. As shown in FIG. 3, a user's input for causing a page flipping event can be a touch-and-drag input composed of a touch action on the right page of an e-book and a drag action from the right page to the left page.

If any page flipping event is not detected at operation 220, the control unit 130 can return to operation 210 and maintain a display state of an e-book.

If a page flipping event is detected, the control unit 130 can select at operation 230 the texture of a page to be flipped.

In case effects on the texture of a page to be flipped are set in advance, the control unit 130 can select the texture of a page to be flipped. Effects on texture can be set and stored as default when an e-book file is distributed by a producer of an e-book. Alternatively or additionally, effects on texture can be set and stored by a user.

Based on setting of a producer of an e-book or a user, the control unit 130 can select the texture of a page to be flipped. In case effects on the texture of a page to be flipped are not set in advance or set as a random mode, the control unit 130 can select one of selectable textures. Such texture can include, for example, a woody surface quality, a metallic surface quality, a papery surface quality, or the like. In an embodiment, if effects on texture are not set, operation 230 can be skipped.

Next, at operation 240, the control unit 130 loads additional information. Specifically, the control unit 130 loads additional information corresponding to an e-book. Additional information can be distributed in advance together with an e-book file by a producer of an e-book. Alternatively, additional information can be downloaded from a suitable web server through the communication unit 110 at the request of the control unit 130. Alternatively, regardless of an e-book file, additional information can be stored earlier in the memory unit 150 by a certain application the electronic device 100 provides.

If necessary, the control unit 130 can directly create additional information in response to a page flipping event. For example, the control unit 130 can create additional information, based on basic information about an e-book, information about a currently displayed page, and any kind of information associated with a user's schedule, message, or the like.

Finally, at operation 250, the control unit 130 controls the display unit 140 to display at least one page in a three-dimensional form as if being flipped and further to display additional information on at least one side thereof.

Specifically, in response to a page flipping event, the control unit 130 controls the display unit 140 to display at least one page as if being flipped.

Namely, the control unit 130 can select at least one page corresponding to a page flipping event. For example, based on the length and direction of a drag input, the strength and direction of a blow input, the magnitude and direction of a tilt of the electronic device 100, or the like, the control unit 130 can select at least one page to be flipped. At this time, the control unit 130 can extract information about at least one page to be flipped, such as the number of such pages, page numbers, chapter numbers, a representative drawing, or the like.

Then the control unit 130 can control the display unit 140 such that the selected page or pages can be displayed as if being flipped. For example, under the control of the control unit 130, the display unit 140 can visually offer an animation effect for a page flipping.

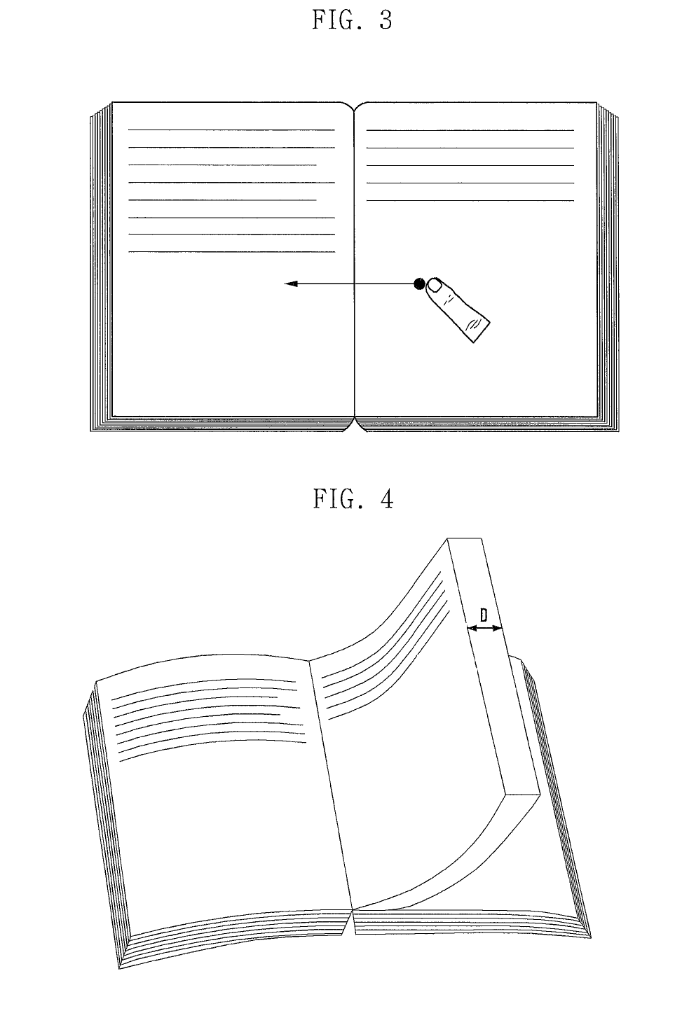

Additionally, the control unit 130 can further control the display unit 140 to display the selected page or pages, being flipped, in a three-dimensional form. For example, the display unit 140 can display at least one selected page in a three-dimensional form as shown in FIG. 4 under the control of the control unit 130. At this time, at least one of a top side, a bottom side and a lateral side of the selected page or pages can be displayed. In FIG. 4, the lateral and bottom sides of the selected pages are displayed for example.

Additionally, the control unit 130 can select the thickness of pages being flipped and displayed in a three-dimensional form. Specifically, the control unit 130 can determine the thickness of at least one page to be displayed corresponding to a page flipping event, and then control the display unit 140 to display the page with the determined thickness. For example, in response to a page flipping event, the control unit 130 can determine the number of pages to be flipped and then, based on the determined number of pages, determine the thickness of pages. In this case, the thickness of pages displayed as if being flipped can depend on the determined number of pages.

Meanwhile, the control unit 130 controls the display unit 140 to further display additional information on at least one side (e.g., a lateral side) of the three-dimensional form that represents the selected pages being flipped.

Additional information can include, but not limited to, at least one of an advertisement, summary information about at least one page, information about an e-book, and index information.

Specifically, as shown in FIG. 5, an advertisement can be displayed as additional information on one side of a three-dimensional form under the control of the control unit 130. Such an advertisement can be stored previously in an e-book file by a producer of an e-book. Alternatively, an advertisement can be downloaded through the communication unit 110 under the control of the control unit 130. In an embodiment, an advertisement can be stored previously in the memory unit 150 by a certain application the electronic device 100 provides.

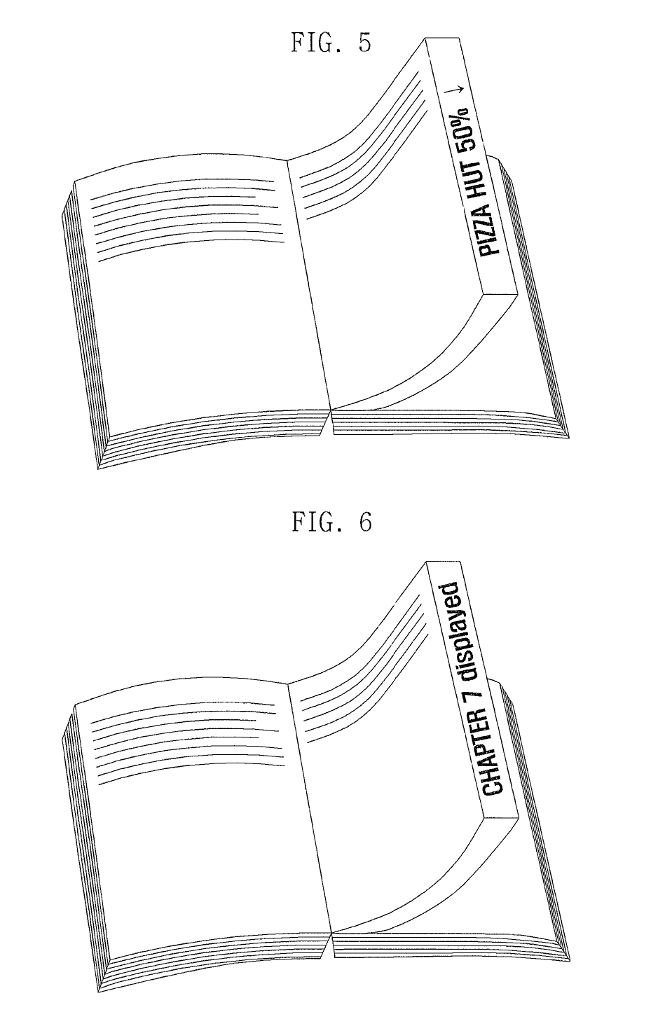

As shown in FIG. 6, summary information about at least one page can be displayed as additional information on one side of a three-dimensional form under the control of the control unit 130. Similarly, information about an e-book, index information, or the like can be displayed as additional information.

Summary information can be information about at least one page being flipped, such as the number of pages, a page number, a chapter number, a chapter title, or the like. Alternatively, summary information can be information about next pages to be displayed after the flipped page or pages, including page numbers, a chapter number, information on content or contents contained in the page, a summary of the page, or the like.

Information on an e-book can include, but not limited to, at least one of a title of an e-book, a producer, a production date, page numbers, a chapter number, and summary information about the content of an e-book.

Index information can indicate index information about at least one page being flipped or pages to be displayed after the flipped page.

As shown in FIG. 6, the control unit 130 can control the display unit 140 to display the above-discussed additional information on one side, e.g., a lateral side, of a three-dimensional form that represents selected pages being flipped.

Under the control of the control unit 130, the display unit 140 displays additional information while at least one page is being flipped. Then when such a flipping is finished, the display unit 140 displays an e-book in which the selected page or pages have been flipped.

Although some examples of additional information are discussed above, this is exemplary only and not to be considered as a limitation. Alternatively, various types of additional information can be also used.

Further, additional information can be displayed on any area of an e-book as well as or instead of on one side of a three-dimensional form that represents selected pages being flipped.

In case the control unit 130 selects the texture of at least one page to be flipped, the display unit 140 can display at least one page on the basis of the selected texture under the control of the control unit 130. This display based on the selected texture can continue while at least one page is being flipped. Additionally, the selected texture can be applied to the entire area of at least one page, to at least one side of a three-dimensional form, or to the specific side on which additional information is displayed.

As fully discussed hereinbefore, an e-book provider or producer can insert additional information such as an advertisement in an e-book such that additional information can be exposed to a user when at least one page is being flipped. Thus, a user who reads an e-book can obtain various types of information about an e-book through additional information.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for displaying an e-book in an electronic device, the method comprising:
displaying the e-book on a screen; and
when a page flipping event is detected on a page of the e-book, flipping the page with additional information displayed on a lateral side of the flipping page.

2. The method of claim 1, wherein the page flipping event happens by at least one of user's inputs including a touch-and-drag, a blow on the electronic device, and a tilting of the electronic device.

3. The method of claim 1, wherein the page comprises front and back sides, top and bottom sides, and the lateral side in a three-dimensional form.

4. The method of claim 1, wherein the displaying the selected page includes:
determining a thickness of the page, the thickness being adequate to display the additional information; and
displaying the page with the determined thickness while being flipped.

5. The method of claim 4, wherein the thickness of the page is determined based on a font size of letters to be displayed.

6. The method of claim 1, wherein the additional information comprises at least one of an advertisement, a summary on the page, information on the e-book, and index information.

7. The method of claim 1, wherein the additional information comprises a title of the e-book.

8. The method of claim 1, wherein the additional information comprises a title of a chapter that the page belongs to.

9. The method of claim 1, wherein the additional information comprises a number of the page being flipped.

10. The method of claim 1, wherein the displaying the page includes:
selecting a texture of the page in a three-dimensional form; and
displaying the page having the selected texture.

11. An electronic device for displaying an e-book, the device comprising:
a screen configured to display the e-book; and
a controller configured to:
detect a page flipping event on a page of the e-book; and
control the screen to display the page being flipped, wherein additional information is displayed on a lateral side of the page while being flipped.

12. The electronic device of claim 11, wherein the page flipping event happens by at least one of a user's inputs including a touch-and-drag, a blow on the electronic device, and a tilting of the electronic device.

13. The electronic device of claim 11, wherein the page comprises at least one of a top side, a bottom side and the lateral side in a three-dimensional form.

14. The electronic device of claim 11, wherein the controller is further configured to:
determine a thickness of the flipping page, the thickness being adequate to display the additional information; and
display the page with the determined thickness while being flipped.

15. The electronic device of claim 11, wherein the thickness of the page is determined based on a font size of letters to be displayed.

16. The electronic device of claim 11, wherein the additional information comprises at least one of an advertisement, summary on the page, information on the e-book, and index information.

17. The electronic device of claim 11, wherein the additional information comprises a title of the e-book.

18. The device of claim 11, wherein the additional information comprises a title of a chapter that the page belongs to.

19. The device of claim 11, wherein the additional information comprises a number of the page being flipped.

20. The device of claim 11, wherein the controller is further configured to:
select a texture of the page the three-dimensional form, and
control the display unit to display the page having the selected texture.
